(19) United States
(12) Patent Application Publication
(10) Pub. No.: US 2009/0063167 A1
(43) Pub. Date: Mar. 5, 2009

(54) HOTEL RATE ANALYTIC SYSTEM

(76) Inventors: Jay Bartot, Seattle, WA (US); Hugh Crean, Seattle, WA (US); Michael Fridgen, Seattle, WA (US); Joel Grus, Seattle, WA (US)

Correspondence Address: PERKINS COIE LLP;PATENT-SEA, P.O. BOX 1247, SEATTLE, WA, 98111-1247, US

(21) Appl. No.: 11/846,507

(22) Filed: Aug. 28, 2007

(51) Int. Cl. G06Q 30/00; G06F 17/10; G06F 17/30; G06F 17/40

(52) U.S. Cl. 705/1; 705/400

(57) ABSTRACT

A hotel deal system provides an observation store with observations that identify a hotel, a stay, a room type, a room rate, and observation date. The hotel deal system receives a request for rate information for a desired hotel for a desired stay. The hotel deal system retrieves current room rate information for the desired hotel for the desired stay. The hotel deal system then analyzes the observations of the observation store to identify a deal rating for the desired hotel for the desired stay at the current room rate.

### BACKGROUND

Many people spend considerable time planning trips to meet their objectives, which generally include minimizing the cost of the trips. For example, a person may want to travel from Seattle to Boston to visit family. Such a person may have considerable flexibility in both when to leave Seattle and how long to stay in Boston. Such a person may be willing to leave any day within the next 30 days and stay for between three and five days in order to get the lowest airfare and hotel room rate possible. Another person may be willing to leave any day within the next week for a stay of two to six days. Such persons typically would be willing to fly on any airline and stay at any convenient hotel that provides acceptable amenities (e.g., at least a three-star hotel rating). It can be, however, very difficult for such persons to identify a hotel with the lowest possible room rate that satisfies their objectives.

To identify a hotel with the lowest possible room rate that satisfies a person's travel objectives, the person may need to visit the web sites of several different hotels and several different hotel aggregators (e.g., Orbitz). Upon visiting a web site, the person would submit a search request with a search criterion that specifies a city or area of a city (e.g., Manhattan) and check-in date and check-out date. The search criterion may also specify a preference for amenities or characteristics of the hotel and hotel room (e.g., three stars, suite, king bed, and fitness center). The web site then identifies the hotels that satisfy the search criterion. If the search criterion is fairly broad, however, it can be time-consuming to search for all the hotels that satisfy the criterion. After the search is completed, the web site provides the person with a list of the identified hotels that may be ordered based on room rate or some other criterion. In addition, the person may perform this search with various combinations of cities and stays (i.e., check-in date and duration combinations). For example, if the person is willing to travel to Orlando, New Orleans, Phoenix, or Los Angeles, the person may need to submit four search requests and manually correlate the results of the hotel amenities and room rates. In addition, since the search results are typically displayed in a list format, it can be difficult for a person to identify a desired hotel and desired stay from a long list.

### BRIEF DESCRIPTION OF THE DRAWINGS

FIG. 1 is the display page that illustrates a user interface for searching for hotel information and displaying deal ratings in some embodiments.

FIG. 2 is a display page that illustrates the display of hotel deal information by the hotel deal system in some embodiments.

FIG. 3 is a block diagram illustrating components of the hotel deal system in some embodiments.

FIG. 4 is a flow diagram that illustrates the processing of the create hotel deal display page component of the hotel deal system in some embodiments.

FIG. 5 is a flow diagram that illustrates the processing of the generate rate score component of the hotel deal system in some embodiments.

FIG. 6 is a flow diagram that illustrates the processing of the generate similar hotel room rate component of the hotel deal system in some embodiments.

FIG. 7 is a flow diagram that illustrates the processing of the generate long-term room rate component of the hotel deal system in some embodiments.

FIG. 8 is a flow diagram that illustrates the processing of a calculate average rate for similar stays component of the hotel deal system in some embodiments.

### DETAILED DESCRIPTION

A method and system for presenting hotel deal information in a way that facilitates identifying travel plans that satisfy objectives is provided. In some embodiments, a hotel deal system may collect hotel information (including room rates) on various observation dates including the current date and present the hotel information to a person in a way that facilitates identifying whether the current room rate for a desired stay at a desired hotel is a good deal relative to similar stays at similar hotels. The hotel deal system may collect the hotel information at specified observation dates (e.g., weekly, once daily, and twice daily) or at a variable observation rate (e.g., weekly during a low-demand period and daily during a high-demand period). If the hotel information is collected more often than daily, then an observation date and time may be associated with each collection of hotel information, referred to as an “observation.” The hotel deal system stores the hotel information in an observation store. To provide hotel information that satisfies a search criterion (e.g., a user request), the hotel deal system retrieves the hotel information that satisfies the search criterion either from hotel information in the observation store or from current hotel information provided in real time from a source of hotel information. As described below in detail, the hotel deal system provides users with indications of whether the current room rate for a desired stay at a desired hotel represents a good deal, an average deal, or a poor deal, referred to as a “deal rating.”

In one embodiment, the hotel deal system (or a system accessible by the hotel deal system) collects observations of hotel information for as many hotels as possible on a daily basis and stores the hotel information in association with its observation date. The hotel deal system may limit the stays for which it retrieves hotel information to stays that have a check-in date within the next 90 days and that are for durations of one to seven nights. One skilled in the art will appreciate that the retrieved hotel information can be, however, for any number of check-in dates and duration combinations. Thus, for each hotel room or class of hotel rooms (e.g., suites) at a certain hotel, the hotel deal system will collect hotel information for 630 stays (e.g., 90*7). The 630 possible stays are illustrated in the following table.

| Stay Number | Check-in Date | Duration |
|---|---|---|
| 1 | 1 | 1 |
| 2 | 1 | 2 |
| 3 | 1 | 3 |
| . . . | | |
| 7 | 1 | 7 |
| 8 | 2 | 1 |
| 9 | 2 | 2 |
| . . . | | |
| 14 | 2 | 7 |
| 15 | 3 | 1 |
| . . . | | |
| 623 | 89 | 7 |
| 624 | 90 | 1 |
| 625 | 90 | 2 |
| . . . | | |
| 630 | 90 | 7 |

In some embodiments, the hotel deal system provides an observation store with observations that identify a hotel, a stay (i.e., check-in date and duration), a room type (e.g., suite or king bed), a room rate, and observation date. The hotel deal system receives a request for rate information for a desired stay at a desired hotel. For example, a user may submit a request for rate information for the Acme Hotel in Chicago, Ill. with a check-in date of Jan. 1, 2008, and duration of two nights (i.e., a check-out date of Jan. 3, 2008). The hotel deal system retrieves current room rate information for the desired stay at the desired hotel. For example, the hotel deal system may access a web service provided by the desired hotel to retrieve rate and availability information. The hotel deal system then analyzes the observations of the observation store to identify the deal rating for the current room rate for the desired stay at the desired hotel. For example, if the current room rate is significantly higher than similar stays at the desired hotel, then the hotel deal system may indicate that the current room rate is a “poor” deal. A similar stay may be, for example, a stay for the next week with a check-in date on the same day of the week and with the same duration. For example, if the desired stay has a check-in date of Tuesday, Jan. 1, 2008, and duration of two nights, then similar stays would have check-in dates of Tuesday, Dec. 25, 2007, and Tuesday Jan. 8, 2008. In this example, the current room rate for a stay starting on Jan. 1, 2008, may be significantly higher than for a stay starting on Jan. 8, 2008, and thus a poor deal relative to similar stays. In contrast, the current room rate for a stay starting on Jan. 1, 2008, for the desired hotel may be a good deal relative to the desired stay at similar hotels.

In some embodiments, the hotel deal system may base the deal rating (e.g., poor, average, or good) on an analysis of room rates for the same or similar stays at the same or similar hotels. The hotel deal system may calculate a historical average of room rates for the desired stay at similar hotels to the desired hotel. For example, a similar hotel may be a hotel that has the same three-star hotel rating as a desired hotel and is within a half-mile of the desired hotel. The hotel deal system may generate a score for the current room rate as the ratio of the calculated average room rate to the current room rate. The larger the ratio the better the deal is relative to the similar hotels. For example, if the average room rate is $200 per night and the current room rate for the desired hotel is $100 per night, then the ratio would be 2. In contrast, if the average room rate is $100 per night and the current room rate for the desired hotel is $200 per night, then the ratio would be 0.5. The hotel deal system may normalize the ratio to generate a score in the range of 0 and 100. For example, the hotel deal system may establish a lower ratio (e.g., 0.7), a middle ratio (e.g., 1.0), and an upper ratio (e.g., 1.5). If the ratio is less than the lower ratio, the score is set to 0. If the ratio is equal to the middle ratio, the score is set to 0.50. If the ratio is greater than the upper ratio, the score is set to 100. Otherwise, the score is set to a linearly interpolated value between 0 and 50 if the ratio is less than the middle ratio or between 50 and 100 if the ratio is greater than the middle ratio. Thus, when the average room rate is $100, a current room rate of $143 would result in a score of 0; a current room rate of $67 would result in a score of 100, and a current room rate of $83 would result in a score of 75. One skilled in the art will appreciate that scores may be generated in many different ways. The hotel deal system may also use a variety of different calculations to determine the deal rating for a current room rate. For example, the hotel deal system may calculate a long-term historical average of room rates for the desired hotel for the desired stay as the average room rate over the past 90 days or 90 observations. As another example, a deal system may calculate a short-term historical average of room rates for the desired hotel for the desired stay as the average room rate over the past seven days or seven observations.

In some embodiments, the hotel deal system may aggregate the scores generated based on different calculations to provide an overall score representing the deal rating. For example, the hotel deal system may calculate a score based on a historical average of room rates for the desired stay at similar hotels to the desired hotel, a long-term historical average of room rates for the desired stay at the desired hotel, and a short-term historical average of room rates for the desired stay at the desired hotel. The hotel deal system may then generate a weighted average of the scores representing the overall score for the current room rate for the desired state at the desired hotel. The weights for the average may be learned using various statistical techniques such as linear regression. The hotel deal system may then map the overall score to a deal rating. For example, scores of 0-25 may represent poor deals, scores of 26-75 may represent average deals, and scores of 76-100 may represent good deals. The hotel deal system may also generate more granular deal ratings such as poor average and good average. The hotel deal system may also represent the deal rating using different colors or highlighting, such as blue to represent a poor deal and red to represent a good deal.

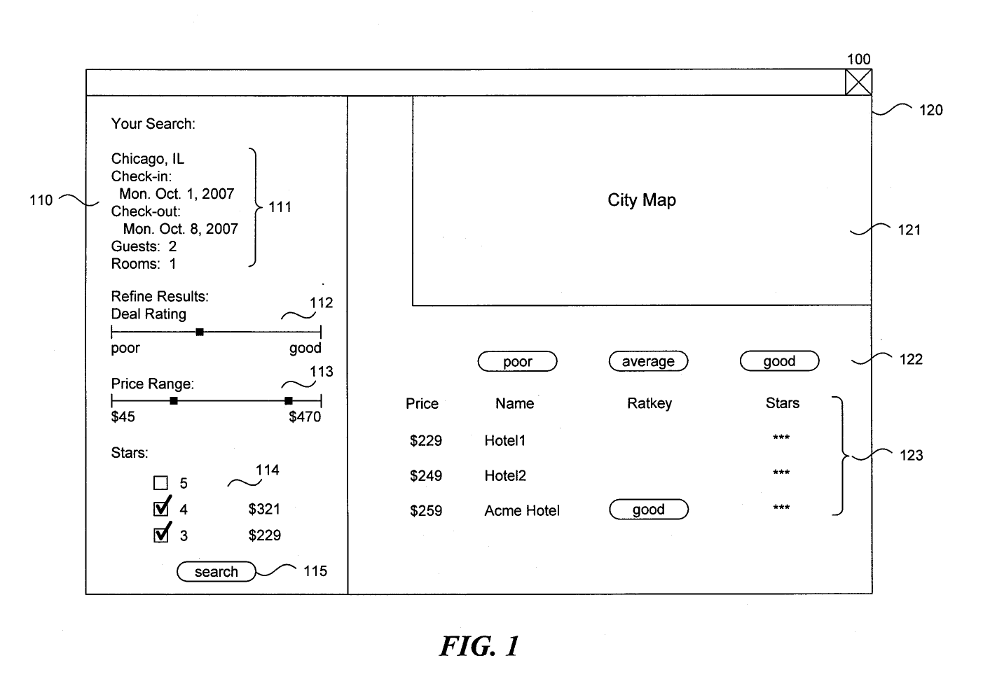

FIG. 1 is the display page that illustrates a user interface for searching for hotel information and displaying deal ratings in some embodiments. A display page 100 includes a search area 110 and a results area 120. The search area may contain stay information 111, a deal rating selection area 112, a price range selection area 113, a hotel rating selection area 114, and a search button 115. In this example, a user may have entered the desired city and the desired stay on a prior display page with the results being displayed in the results area. The results area may include a map 121 of the city with the location of the listed hotels highlighted. The results area may also include a legend 122 defining the deal ratings such as by color or shape. The results area also includes a list 123 of the room rates for the desired stay at various hotels in the city. In this example, the room rate for the Acme Hotel is $259 and has been given a deal rating of good. Although the current room rate is not the lowest rate for similar hotels, it may be significantly lower than the long-term and short-term historical room rates for the desired stay at the Acme Hotel. A user may refine the search results by selecting a minimum deal rating, a price range, and hotel characteristics and amenities such as hotel star rating.

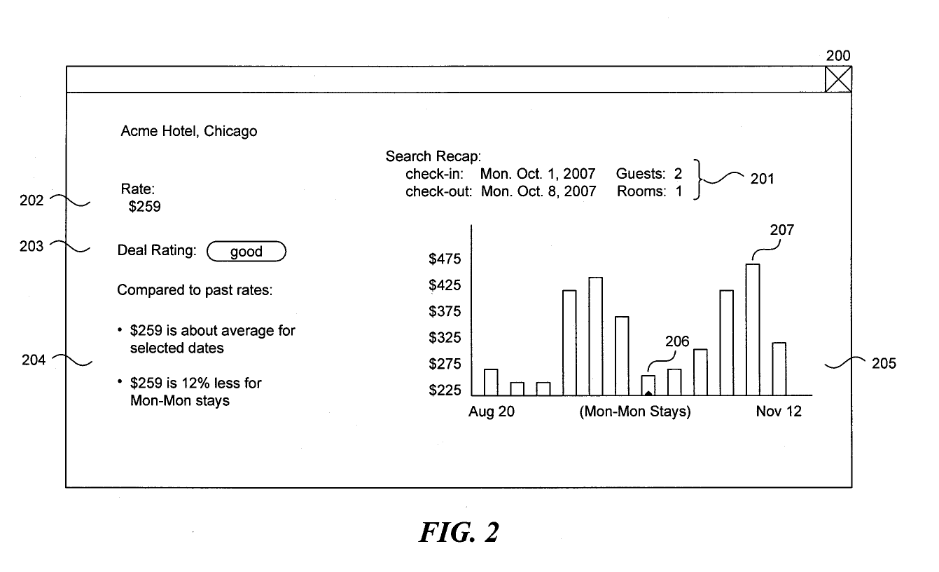

FIG. 2 is a display page that illustrates the display of hotel deal information by the hotel deal system in some embodiments. A display page 200 includes a stay information area 201, a rate area 202, a deal rating area 203, a comparison area 204, and a graph area 205. The stay information area describes the desired stay to which the hotel information of the display page pertains. The rate area provides the current room rate for the desired hotel for the desired stay. The deal rating area provides the deal rating for the desired stay at the desired hotel. The comparison area provides information justifying the deal rating. In this example, the current room rate is about average for the desired stay. However, the current room rate is 12 percent less than similar stays at the desired hotel. The graph area contains a graph of room rates for similar stays to the selected stay at the selected hotel. In this example, the desired stay has a check-in date of Monday, Oct. 1, 2007, and duration of seven nights. Thus, the desired stay is a Monday-to-Monday stay. The graph illustrates the current room rate for Monday-to-Monday stays with a duration of seven nights from Aug. 20, 2007, to Nov. 12, 2007. The bar 206 illustrates the room rate for the desired stay starting on Oct. 1, 2007. Each bar of the graph may be highlighted (e.g., coloring, shading, cross-hatching) in a way to indicate its deal rating. For example, bar 206 may be colored red to indicate that its deal rating is good, whereas bar 207 may be colored blue to indicate its deal rating is poor. When a user selects a bar, the hotel deal system may search for hotel information for similar hotels for a desired stay corresponding to the stay represented by the bar. The display page of FIG. 2 may be displayed when a user selects a hotel listed in the results area of the display page of FIG. 1.

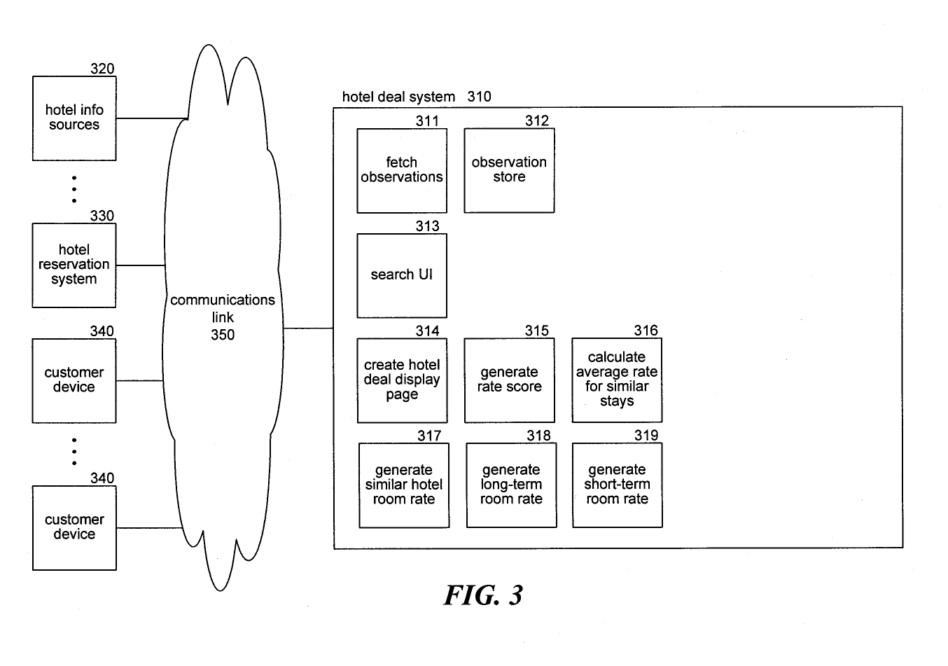

FIG. 3 is a block diagram illustrating components of the hotel deal system in some embodiments. The hotel deal system 310 may communicate with hotel information sources 320, hotel reservation systems 330, and customer devices 340 via communications link 350. The hotel information sources provide current room rate information for hotels for various stays. The hotel reservation systems allow hotel rooms to be reserved. The customer devices may use web browsers to interact with the hotel deal system to search for hotel rooms, identify deals, and reserve hotel rooms. The hotel deal system may include a fetch observations component 311 and an observation store 312. The fetch observations component may periodically access the hotel information sources to collect observations for various hotels for various check-in dates and durations. The fetch observations component stores the observations in the observation store. The hotel deal system includes a search user interface component 313 that assists users in searching for hotel information. The hotel deal system also includes a create hotel deal display page component 314, a generate rate score component 315, a calculate average rate for similar stays component 316, a generate similar hotel room rate component 317, a generate long-term room rate component 318, and a generate short-term room rate component 319. The search user interface component invokes the create hotel deal display page to display hotel deal information via a display page such as that shown in FIG. 2. The create hotel deal display page component invokes the generate rate score component to generate a rate score for the current room rate for a desired hotel for a desired stay. The component then identifies the deal rating from the generated rate score. The component also invokes the calculate average rate for similar stays component to provide some justification for the deal rating. The generate rate score component invokes a generate similar hotel room rate component to calculate average room rates for similar hotels for the desired stay. The generate rate score component also invokes a generate long-term room rate component to calculate average long-term historical room rates for the desired hotel at the desired stay. The generate rate score component invokes a generate short-term room rate component to calculate an average short-term historical room rate for the desired hotel at the desired stay.

The computing devices on which the hotel deal system may be implemented may include a central processing unit, memory, input devices (e.g., keyboard and pointing devices), output devices (e.g., display devices), and storage devices (e.g., disk drives). The memory and storage devices are computer-readable media that may contain instructions that implement the hotel deal system. In addition, the data structures may be stored or transmitted via a data transmission medium, such as a signal on a communications link. Various communications links may be used to connect the deal identification system to flight information sources and user computing devices, such as the Internet, a local area network, a wide area network, a point-to-point dial-up connection, a cell phone network, and so on.

Embodiments of the hotel deal system may be implemented in or used with various operating environments that include personal computers, server computers, multiprocessor systems, microprocessor-based systems, minicomputers, mainframe computers, distributed computing environments that include any of the above systems or devices, and so on. The user devices may include cell phones, personal digital assistants, smart phones, personal computers, programmable consumer electronics, digital cameras, and so on.

The hotel deal system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, the fetching of the observations and providing of the user interface may be provided by different computer systems.

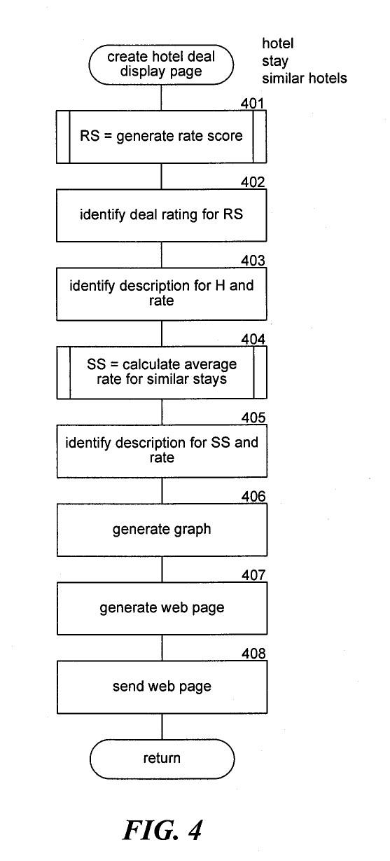

FIG. 4 is a flow diagram that illustrates the processing of the create hotel deal display page component of the hotel deal system in some embodiments. The component may be passed an indication of a desired hotel, a desired stay, and similar hotels. The component generates a display page providing deal information. In block 401, the component invokes a generate rate score component to generate a rate score for the current room rate for the desired hotel at the desired stay. In block 402, the component identifies a deal rating (e.g., poor, average, good) for the generated rate score. In block 403, the component identifies a comparison description for long-term historical rates compared to the current room rate. In block 404, the component invokes the calculate average rate for similar stays component to calculate the average room rate for similar stays at the desired hotel. In block 405, the component identifies a comparison description for the average room rate for similar stays and the current room rate. In block 406, the component generates a graph illustrating the room rates for similar stays at the desired hotel. In block 407, the component generates a web page that includes the graph and the deal rating. In block 408, the component sends the web page to the user and then completes.

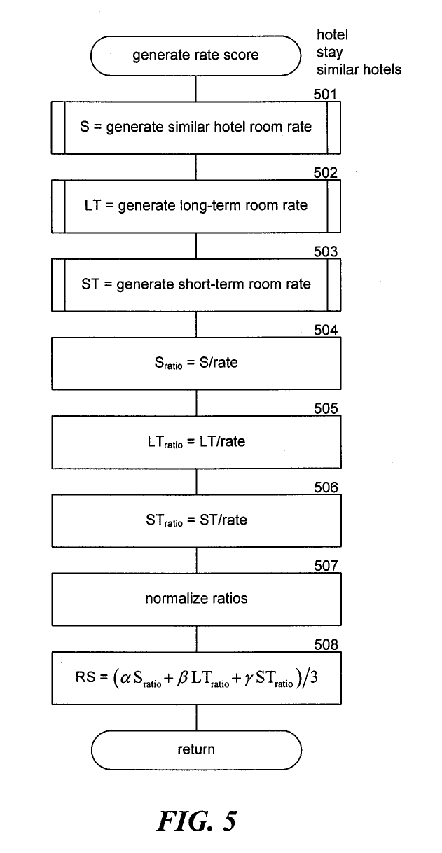

FIG. 5 is a flow diagram that illustrates the processing of the generate rate score component of the hotel deal system in some embodiments. The component is passed an indication of the desired hotel and the desired stay along with an indication of the similar hotels. In block 501, the component invokes the generate similar hotel room rate component to calculate an average room rate for the desired stay for similar hotels to the desired hotel. In block 502, the component invokes the generate long-term room rate component to calculate an average room rate over a long term for the desired stay at the desired hotel. In block 503, the component invokes the generate short-term room rate component to calculate an average room rate over a short term for the desired stay at the desired hotel. In block 504, the component calculates a ratio of the average of the room rates for similar hotels to the current room rate. In block 505, the component calculates the ratio of the average of the long-term room rates to the current room rate. In block 506, the component calculates the ratio of the average of the room rates over the short term to the current room rate. In block 507, the component normalizes the ratios to between 0 and 100. In block 508, the component calculates a rate score as the weighted average of the various ratios and then returns.

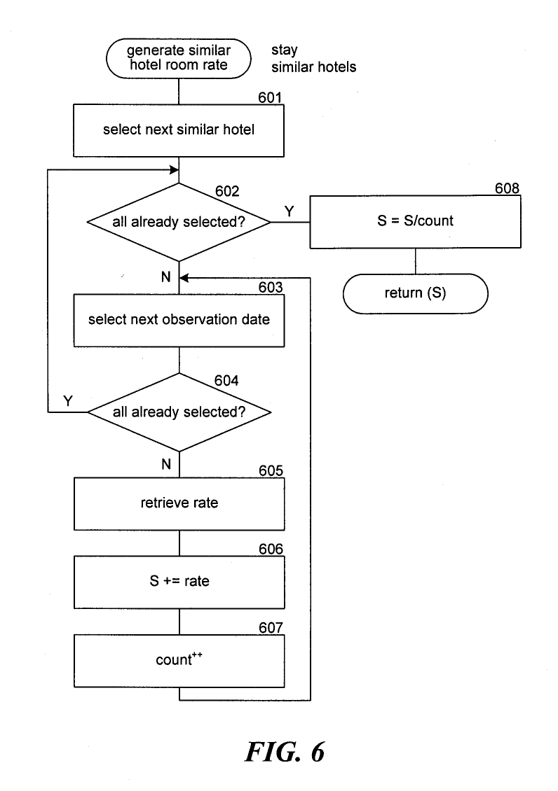

FIG. 6 is a flow diagram that illustrates the processing of the generate similar hotel room rate component of the hotel deal system in some embodiments. The component is passed an indication of the desired stay and an indication of the similar hotels. The component calculates an average historical room rate for similar hotels for the desired stay. In block 601, the component selects the next similar hotel. In decision block 602, if all the similar hotels have already been selected, then the component continues at block 608, else the component continues at block 603. In block 603, the component selects the next observation date for the selected similar hotel. In decision block 604, if all such observation dates have already been selected, then the component loops to block 601 to select the next similar hotel, else the component continues at block 605. In block 605, the component retrieves the room rate of the selected observation date. In block 606, the component accumulates the retrieved room rate. In block 607, the component increments the count of the number of observations contributing to the accumulated rate. The component then loops to block 603 to select the next observation date for the selected similar hotel. In block 608, the component sets the similar hotel room rate to the accumulated rate divided by the count. The component then returns the average similar hotel room rate.

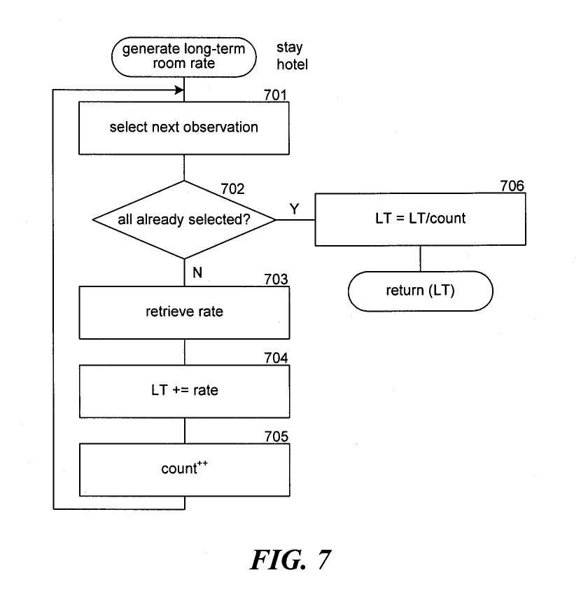

FIG. 7 is a flow diagram that illustrates the processing of the generate long-term room rate component of the hotel deal system in some embodiments. The component is passed an indication of a desired stay and a desired hotel. The component calculates the average room rate for the desired stay at the desired hotel over the long term. The long term may be defined as the past 90 days. In block 701, the component selects the next observation for the desired hotel for the desired stay. In block 702, if all such observations have already been selected, then the component continues at block 706, else the component continues at block 703. In block 703, the component retrieves the room rate for the selected observation. In block 704, the component accumulates the retrieved room rates. In block 705, the component increments the count of the number of observations contributing to the accumulated room rate. The component then loops to block 701 to select the next observation. In block 706, the component calculates the average long-term room rate by dividing the accumulated long-term room rate by the count. The component then returns the average long-term room rate. Although not shown in a separate figure, the hotel deal system includes a generate short-term rate component that operates in an analogous manner to the generate long-term room rate component except that the short-term represents only more recent observations.

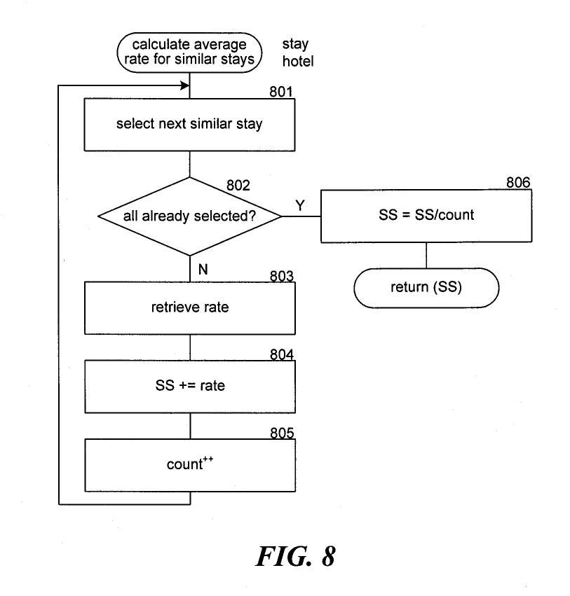

FIG. 8 is a flow diagram that illustrates the processing of a calculate average rate for similar stays component of the hotel deal system in some embodiments. The component is passed a desired stay and a desired hotel. The component calculates an average room rate for similar stays for the desired hotel. In block 801, the component selects the next similar stay to the desired stay. In decision block 802, if all similar stays have already been selected, then the component continues at block 806, else the component continues at block 803. In block 803, the component retrieves the current room rate for the selected similar stay for the desired hotel. In block 804, the component accumulates the room rates. In block 805, the component increments a count of the number of similar stays that contribute to the accumulated room rate. The component then loops to block 801 to select the next similar stay. In block 806, the component divides the accumulated room rate by the count to generate an average room rate for the similar stays. The component then returns.

From the foregoing, it will be appreciated that specific embodiments of the invention have been described herein for purposes of illustration, but that various modifications may be made without deviating from the spirit and scope of the invention. One skilled in the art will appreciate that many different analytical techniques may be used to determine whether a current room rate is a deal. Various statistical measurements may be used such as standard deviations. For example, current room rates that are above or below an average rate by one or more standard deviations may be considered to be poor or good deals. The deal identification system may also generate histograms of room rates and designate rates within the lower-priced groupings to be good deals. Alternatively, the deal identification system may segregate the rates in to quartiles, quintiles, or deciles and select the lower-priced grouping as good deals. Accordingly, the invention is not limited except as by the appended claims.

I/We claim:

1. A method in a computing device for presenting hotel deals, the method comprising:
providing on observation store with observations, each observation identifying a hotel, a stay, a rate, and an observation date;
receiving a request for rate information for a desired hotel for a desired stay;
retrieving a current rate for the desired hotel for the desired stay;
analyzing the observations of the observation store to identify a deal rating for the desired hotel for the desired stay at the current rate; and
outputting an indication of the identified deal rating for the desired hotel for the desired stay at the current rate.

2. The method of claim 1 wherein the analyzing of the observations includes calculating a historical average of rates for similar hotels to the desired hotel for the desired stay.

3. The method of claim 1 wherein the analyzing of the observations includes calculating a long-term historical average of rates for the desired hotel for the desired stay.

4. The method of claim 1 wherein the analyzing of the observations including calculating a short-term historical average of rates for the desired hotel for the desired stay.

5. The method of claim 1 wherein the analyzing of the observations includes calculating a historical average of rates for similar hotels to the desired hotel for the desired stay, calculating a long-term historical average of rates for the desired hotel for the desired stay, and calculating a short-term historical average of rates for the desired hotel for the desired stay.

6. The method of claim 5 including generating a rate score that is based on ratios of the calculated averages to the current rate.

7. The method of claim 6 including identifying the deal rating that is based on the generated rate score.

8. The method of claim 1 wherein the outputting includes creating a display page that includes an indication of the identified deal rating and a graph indicating the rate of similar stays to the desired stay at the desired hotel.

9. The method of claim 8 including when a similar stay is selected, displaying rate information for similar hotels to the desired hotel for the selected similar stay.

10. The method of claim 1 including generating a comparison of the current rate for the desired hotel for the desired stay to past rates for the desired hotel for the desired stay.

11. The method of claim 1 including generating a comparison of the current rate for the desired stay at the desired hotel the current rate for similar stays at the desired hotel.

12. The method of claim 1 wherein the analyzing of the observations includes calculating a historical average of rates for similar hotels to the desired hotel for the desired stay, calculating a long-term historical average of rates for the desired hotel for the desired stay, and calculating a short-term historical average of rates for the desired hotel for the desired stay; generating a rate score that is based on ratios of the calculated averages to the current rate and identifying the deal rating that is based on the generated rate score; and creating a display page that includes an indication of the identified deal rating and a graph indicating rate of similar stays to the desired stay at the desired hotel.

13. A computer-readable medium embedded with instructions for controlling a computing device to identify a deal rating of a current rate for a desired hotel for a desired stay, by a method comprising:
providing on observation store with observations, each observation identifying a hotel, a stay, a rate, and an observation date;
analyzing the observations of the observation store to identify the deal rating for the desired hotel for the desired stay at the current rate, the deal rating based on a historical average of rates for similar hotels to the desired hotel for the desired stay, a long-term historical average of rates for the desired hotel for the desired stay, and a short-term historical average of rates for the desired hotel for the desired stay; and
outputting an indication of the identified type of deal for the desired hotel for the desired stay at the current rate.

14. The computer-readable medium of claim 13 wherein the analyzing of the observations includes generating a rate score that is based on ratios of the averages to the current rate.

15. The computer-readable medium of claim 14 wherein the analyzing of the observations includes identifying the deal rating based on the generated rate score.

16. The computer-readable medium of claim 13 wherein the outputting includes creating a display page that includes an indication of the identified deal rating and a graph indicating the rate of similar stays to the desired stay at the desired hotel.

17. The computer-readable medium of claim 16 including when a similar stay is selected, displaying rate information for similar hotels to the desired hotel for the selected similar stay.

18. The computer-readable medium of claim 13 including generating a comparison of the current rate for the desired hotel for the desired stay to past rates for the desired hotel for the desired stay.

19. The computer-readable medium of claim 13 including generating a comparison of the current rate for the desired stay at the desired hotel to the current rate for similar stays to the desired stay at the desired hotel.

20. The computer-readable medium of claim 13 wherein an observation includes a room attribute.

21. A system for presenting deal ratings for hotel stays, comprising:
a component that receives from a user a request for rate information for a desired hotel for a desired stay;
a component that sends to a server an indication of the desired hotel and a desired stay wherein the server retrieves a current rate for the desired hotel and the desired stay, identifies a deal rating for the current rate for the desired hotel and the desired stay based on an analysis of observations identifying a hotel, a stay, a rate, and an observation date, and provides a display page indicating the identified deal rating; and
a component that receives from the server a display page indicating the identified deal rating and displays the received display page to the user.

22. The system of claim 21 wherein the server analyzes the observations by calculating a historical average of rates for similar hotels to the desired hotel for the desired stay.

23. The system of claim 21 wherein the server analyzes the observations by calculating a long-term historical average of rates for the desired hotel for the desired stay.

24. The system of claim 21 wherein the server analyzes the observations by calculating a short-term historical average of rates for the desired hotel for the desired stay.

25. The system of claim 21 wherein the display page includes a graph indicating the rate of similar stays to the desired stay at the desired hotel.

26. The system of claim 25 including a component that displays rate information for similar hotels to the desired hotel for the selected similar stay.

27. The system of claim 21 wherein the display page includes a comparison of the current rate for the desired hotel for the desired stay to past rates for the desired hotel for the desired stay.

28. The system of claim 21 wherein the display page includes a comparison of the current rate for the desired stay at the desired hotel to the current rate for similar stays to the desired stay at the desired hotel.
